(19) United States
(12) Patent Application Publication
(10) Pub. No.: US 2008/0040034 A1
(43) Pub. Date: Feb. 14, 2008

(54) Route searching device

(75) Inventor: Hiroyuki Kanno, Miyagi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/882,920

(22) Filed: Aug. 7, 2007

(30) Foreign Application Priority Data
Aug. 8, 2006 (JP) 2006-215456

(51) Int. Cl. G01C 21/34; G01S 5/00

(52) U.S. Cl. 701/210

(57) ABSTRACT

A GPS-equipped electronic camera takes images of destinations. A memory card set to the electronic camera stores image files to which shooting position data is added. The shooting position data represents a position where shooting has been performed. The memory card is set to a car navigation equipment. A shooting-position-data extracting portion extracts the shooting position data from the image file corresponding to the destination. A route searching portion searches a route leading from a present location to the destination on the basis of the extracted shooting position data, road map data stored in a storage portion, and present location data obtained by a GPS antenna and a present-location-data calculator. Since it is unnecessary to input an address and a phone number of the destination, setting the destination is easily performed.

### FIELD OF THE INVENTION

The present invention relates to a route searching device for searching a route from a present location to a desired destination.

### BACKGROUND OF THE INVENTION

In recent years, it becomes popular to equip an automobile with a car navigation system for obtaining positional data of a present location by utilizing GPS (Global Positioning System) (see Japanese Patent Laid-Open Publication No. 2002-271723). As to the car navigation system, a user sets a destination by inputting an address, a phone number and so forth of a facility and a shop of the destination with a remote controller or the like. Upon completion of setting, the car navigation system searches a traveling route from the present location to the destination on the basis of the positional data of the present location and rode map data recorded in a hard disk drive and so forth. The searched traveling route is displayed.

By the way, a conventional car navigation system has a problem that it is impossible to set a destination when an address, a phone number and so forth thereof are unknown or are forgotten. In order to perform setting of the destination, a user is required to refer to the address, the phone number and so forth of the destination transcribed on a paper or the like. Alternatively, the user is required to correctly memorize the address, the phone number and so forth. Meanwhile, even when the address and the phone number of the destination are known, it takes time and effort to input the address and the phone number. For this reason, it is strongly desired to develop the car navigation system in which setting of the destination can be easily performed.

### SUMMARY OF THE INVENTION

In view of the foregoing, it is a primary object of the present invention to provide a route searching device for a car navigation equipment and so forth, in which setting of a destination can be easily performed.

In order to achieve the above and other objects, the route searching device according to the present invention comprises a data obtaining portion, a map-data storage portion, an image-file input portion and a route searching portion. The data obtaining portion obtains present-location data representing a present location. The map-data storage portion stores map data. The image-file input portion inputs an image file in which destination-position data representing a position of a destination is added in advance to image data representing an image of the destination. The route searching portion searches a route leading from the present location to the destination on the basis of the present-location data, the map data and the destination-position data of the image file.

It is preferable to further comprise a display and a destination selector. When the plural image files are inputted into the image-file input portion, the display shows the images of the destinations corresponding to the respective image files. The destination selector selects at least one of the images shown on the display. In a preferred embodiment, the destination selector selects the images of the halfway destination and the final destination from among the images shown on the display. The route searching device further comprises an extract portion for extracting the destination position data from the image files corresponding to all the images selected by the destination selector. The route searching portion searches the route leading from the present location to the final destination via the halfway destination on the basis of all the destination position data extracted by the extract portion.

It is preferable that the image file is produced by an imaging device capable of adding shooting position data, which represents a position where shooting has been performed, to the image data as the destination position data.

It is preferable that the image file to be inputted into the image-file input portion is produced by the above-mentioned imaging device and is obtained through the Internet.

According to the route searching device of the present invention, setting the destination is easily performed without inputting an address and a phone number of the destination such as conventionally performed. Consequently, it is unnecessary to transcribe the address and the phone number of the destination on a paper, and it is also unnecessary to memorize them. Further, it is possible to easily set the halfway destination and the final destination. Furthermore, since the image file is obtainable via the Internet, the image file of the destination desired by the user can be easily obtained even when the user does not have this image file.

### BRIEF DESCRIPTION OF THE DRAWINGS

FIG. 1 is a block diagram showing an electrical structure of an electronic camera;

FIG. 2 is an explanatory illustration showing an image file stored in a memory card;

FIG. 3 is a block diagram showing an electrical structure of a car navigation equipment;

FIG. 4 is a front view of an LCD of the car navigation equipment wherein a list of thumbnail images of destinations is displayed;

FIG. 5 is an explanatory illustration showing a map image, which is displayed on the LCD of the car navigation equipment to indicate an icon of a present location, an icon of a destination and a traveling route leading from the present location to the destination;

FIG. 6 is an explanatory illustration showing a map image, which is displayed on the LCD of the car navigation equipment to indicate an icon of a present location, an icon of a halfway destination, an icon of a final destination and a traveling route leading from the present location to the final destination via the halfway destination;

FIG. 7 is a flowchart explaining a route searching process of the car navigation equipment; and

FIG. 8 is an explanatory illustration showing that an image file of a destination is obtainable via the Internet.

### DESCRIPTION OF THE PREFERRED EMBODIMENTS

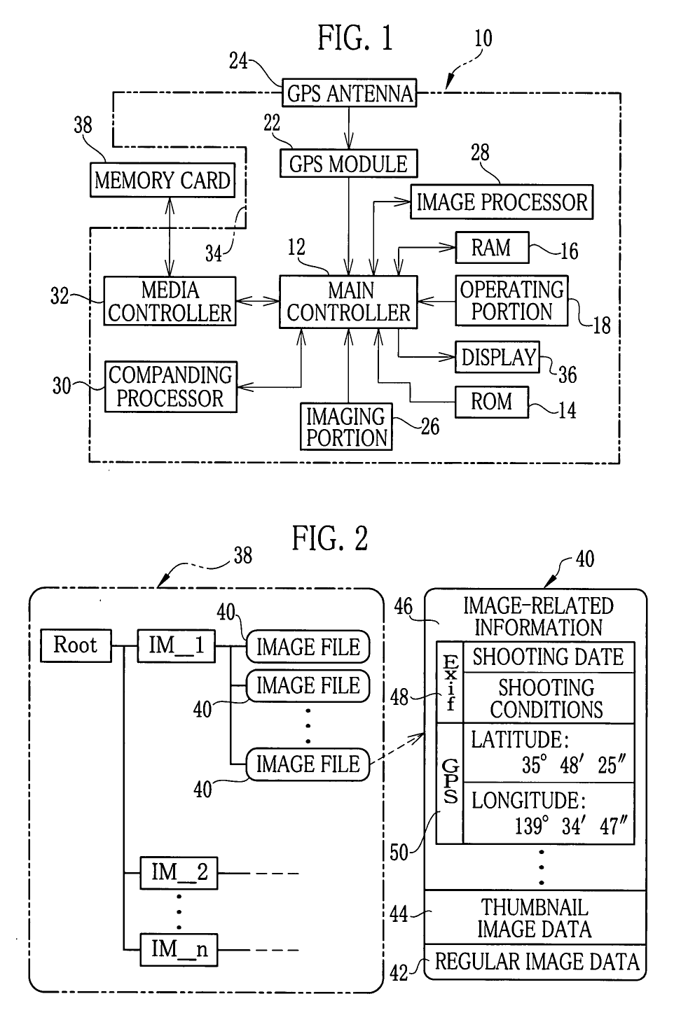

A GPS-equipped electronic camera (hereinafter, simply called as electronic camera) 10 shown in FIG. 1 corresponds to an imaging device of the present invention and is utilized for setting a destination in a car navigation equipment described later. The electronic camera 10 comprises a main controller 12, a ROM 14, a RAM 16, an operating portion 18, a GPS module 22, a GPS antenna 24, an imaging portion 26, an image processor 28, a companding processor 30, a media controller 32, a card slot 34 and a display 36.

The main controller 12 reads a control program stored in the ROM 14 and sends this program to the RAM 16 of a working memory. Along the control program, the respective portions of the electronic camera 10 are integrally controlled.

The operating portion 18 is composed of a power button, a release button, a mode selection dial and so forth. On the basis of an operation signal outputted from the operating portion 18, the main controller 12 controls an operation of each portion of the camera 10. After framing a subject, the release button is lightly pressed (halfway). Upon this, are performed various shooting preparations including determination of exposure conditions (AE), autofocus adjustment (AF) and so forth. In this state, the release button is pressed again strongly (in full) to perform a single shooting under the determined exposure conditions. The mode dial is rotated to selectively switch a still-image shooting mode for taking a still image, a reproducing mode for showing the taken image on the display 36, and a setting mode for performing various kinds of setting.

The GPS module 22 is connected to the GPS antenna 24 disposed on an upper side of a camera body (not shown) of the electronic camera 10. The GPS module 22 receives radio waves from GPS satellites (not shown) via the GPS antenna 24 to produce shooting position data (GPS data) representing a position where a subject has been taken. The shooting position data includes latitude data and longitude data. The shooting position data produced by the GPS module 22 is stored in the RAM 16.

The imaging portion 26 comprises an imaging optical system, a CCD image sensor, an A/D converter and so forth to convert an image, which is obtained by shooting a subject, into digital data (CCD-RAW data) to be outputted. The CCD-RAW data outputted from the imaging portion 26 is temporarily stored in the RAM 16. The image processor 28 reads the CCD-RAW date from the RAM 16 to perform various kinds of image processing including color interpolation processing, white-balance correction processing and gamma correction processing. The processed image data is stored in the RAM 16 again.

The companding processor 30 compresses the image data read from the RAM 16, in a predetermined file format (JPEG format, for instance). In addition, the companding processor 30 adds the shooting position data produced by the GPS module 22, to the image data as a tag. The image data compressed by the companding processor 30 is stored in the RAM 16 again. Further, the companding processor 30 performs expansion processing of the compressed image data at a time of the reproducing mode.

The media controller 32 controls recording and reading of the image data (file) for a memory card 38 set to the card slot 34. The media controller 32 records the image data stored in the RAM 16 in the memory card 38. Further, the media controller 32 reads the image data recorded in the memory card 38, at the time of the reproducing mode.

The display 36 is composed of an LCD (Liquid Crystal Display) and an LCD driver, although illustration thereof is omitted. The LCD driver is connected to a VRAM (not shown) used for storing the CCD-RAW data of two frames read out of the RAM 16. Writing and reading the CCD-RAW data are concurrently performed for the VRAM. The LCD driver converts the CCD-RAW data read out of the VRAM, into an analog composite signal to display this data on the LCD as a through image. In addition, the LCD driver displays the image data expanded by the companding processor 30, on the LCD as a reproduction image.

When the release button 18 has been fully pressed to perform shooting at the time of the still-image shooting mode, a still image is taken on the basis of the determined exposure amount and the CCD-RAW data obtained thereby is stored in the RAM 16. Simultaneously, the shooting position data produced by the GPS module 22 is stored in the RAM 16. Successively, for the CCD-RAW data stored in the RAM 16, various kinds of image processing are performed by the image processor 28. After that, the CCD-RAW data is stored in the RAM 16 again as the image data. And then, the image data stored in the RAM 16 is compressed by the companding processor 30 and is stored in the RAM 16 after adding the shooting position data as the tag. The image data stored in the RAM 16 is recorded in the memory card 38 by the media controller 32.

FIG. 2 shows a directory structure of the memory card 38. As shown in FIG. 2, under a root directory “Root”, subdirectories “IM_1”, “IM_2” . . . “IM_n” are made. In each of the subdirectories “IM_1” to “IM_n”, image files 40 are recorded. In the image file, the image data of the taken subject is written.

The image file 40 is composed of regular image data 42, thumbnail image data 44 and image-related information (tag information) 46. The regular image data 42 is JPEG compression still-image data of a pixel number set by a user, for example of XGA, or 1024×764 pixels. The thumbnail image data 44 is JPEG compression still-image data of 160×120 pixels, for example. The thumbnail image data 44 is produced by JPEG compression after resizing the regular image data 42.

The image-related information 46 includes Exif data 48, the above-mentioned shooting position data (GPS data) 50 and so forth. In the Exif data 48, a shooting date and shooting conditions (exposure conditions, shutter speed and so forth) are recorded. As described above, the shooting position data 50 is composed of the latitude data and the longitude data.

In this way, the shooting position data 50 representing the shooting position, or the subject position, is added to the image file 40 (regular image data 42) obtained by taking the subject with the electronic camera 10 (see FIG. 1). Consequently, when a sightseeing spot, a facility, a shop and so forth are taken with the electronic camera 10, the shooting position data 50 representing the positions of them are added to the image file 40. In a car navigation equipment 60 described below, route searching is performed by utilizing the shooting position data (destination position data) added to the image file 40 obtained by taking the destination (the sightseeing spot, the facility, the shop and so forth) with the electronic camera 10.

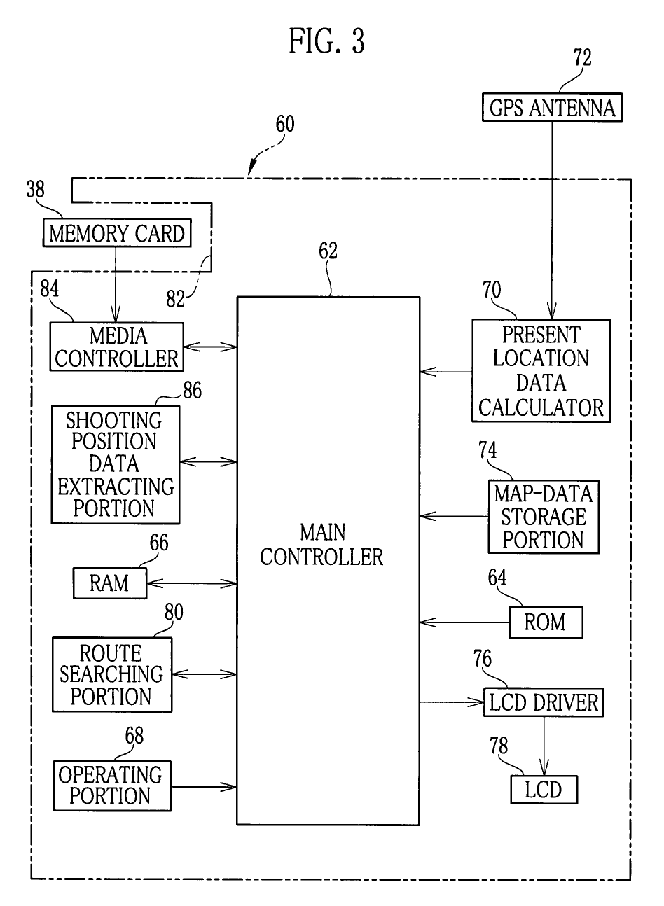

The car navigation equipment 60 shown in FIG. 3 corresponds to a route searching device of the present invention and is installed in an automobile not shown. The car navigation equipment 60 comprises a main controller 62, a ROM 64, a RAM 66, an operating portion 68, a present-location-data calculator 70, a GPS antenna 72, a map-data storage portion 74, an LCD driver 76, a liquid-crystal display (LCD) 78, a route searching portion 80, a memory card slot 82, a media controller 84, and a shooting-position-data extracting portion 86.

The main controller 62 reads a control program stored in the ROM 64 and sends this program to the RAM 66 of a working memory. Along the control program, the respective portions of the car navigation equipment 60 are integrally controlled. The operating portion 68 is used for setting and selection of a destination and for making various kinds of setting of the car navigation equipment 60. The main controller 62 controls an operation of each portion of the car navigation equipment 60 on the basis of an operation signal outputted from the operating portion 68.

The present-location-data calculator 70 is connected to the GPS antenna 72 disposed on a dashboard (not shown) of an automobile. The present-location-data calculator 70 and the GPS antenna 72 compose a present-location-data obtaining portion of the present invention. The present-location-data calculator 70 receives radio waves from the GPS satellites (not shown) via the GPS antenna 72 to calculate the present location data (latitude/longitude) representing the current position of the automobile. By virtue of the present-location-data calculator 70 and the GPS antenna 72, it is possible to obtain the present location data of the automobile in real time. The present location data is inputted into the main controller 62.

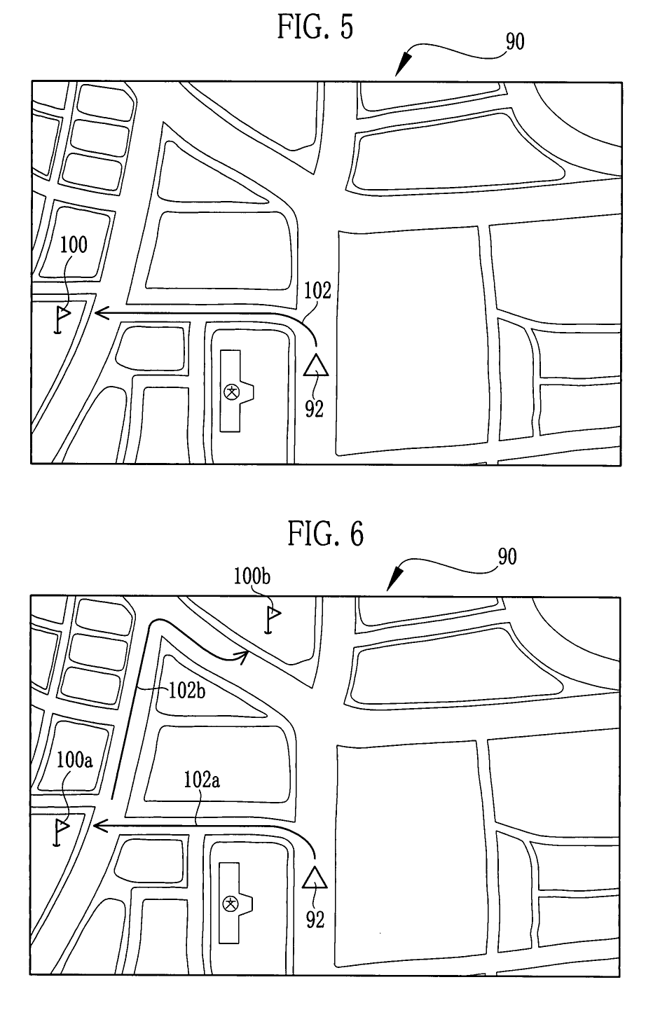

The map-data storage portion 74 is a hard disk drive storing road map data. Alternatively, the map-data storage portion 74 may be a CD-ROM drive and a DVD-ROM drive to which a storage medium storing road map data is set. The main controller 62 reads the road map data representing the vicinity of the present location, from the map-data storage portion 74 on the basis of the present location data inputted from the present-location-data calculator 70. Successively, the main controller 62 displays a map image 90 (see FIG. 5) on the LCD 78 via the LCD driver 76. Further, the main controller 62 displays an icon 92 (see FIG. 5), which represents the present location, via the LCD driver 76 on the map image 90 displayed on the LCD 78.

The route searching portion 80 searches a route leading from the present location to the destination on the basis of the present location data, which is inputted into the main controller 62, and destination location data described later in detail.

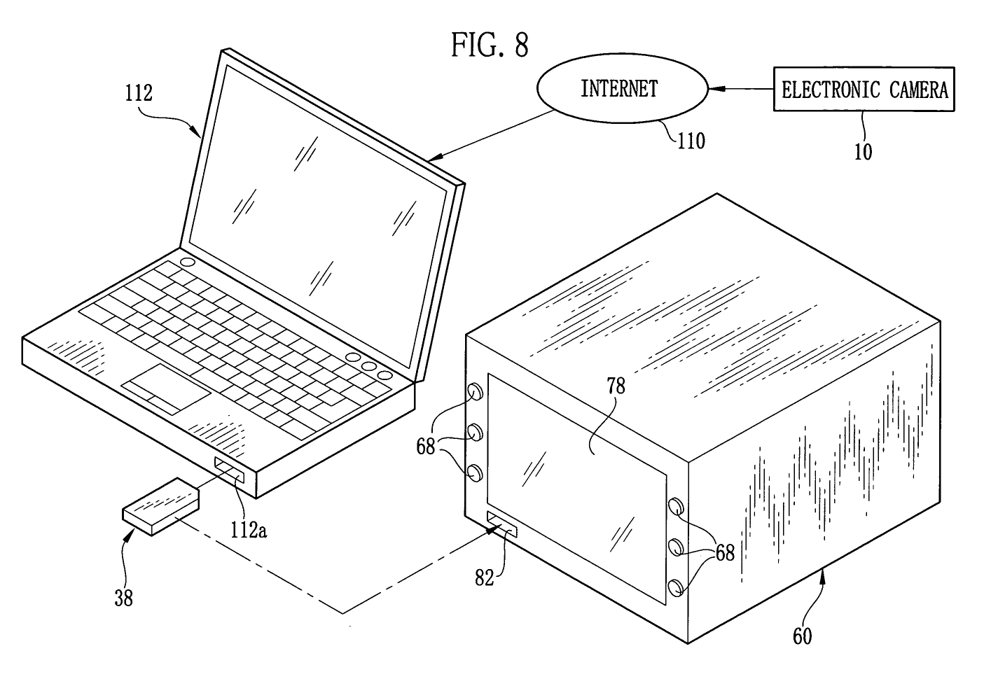

To the memory card slot 82 (see FIG. 8), the above-mentioned memory card 38 is set. The memory card 38 stores the image file 40 obtained by taking the subject regarded as the destination (the sightseeing spot, the facility, the shop and so forth) with the electronic camera 10. The media controller 84 controls the readout of the image file 40 stored in the memory card 38.

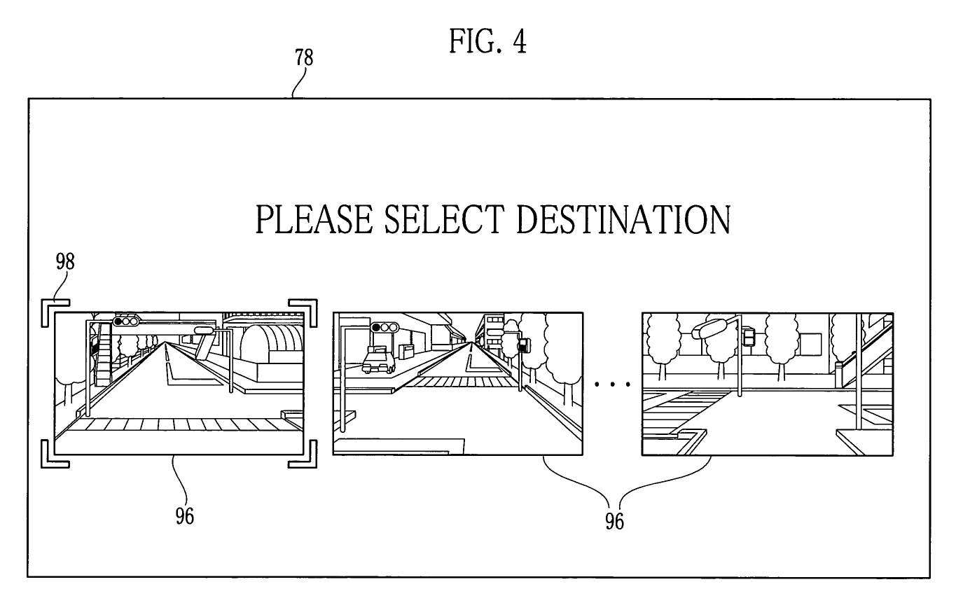

Upon setting the memory card 38 to the memory card slot 82, the media controller 84 reads the respective image files 40 of the memory card 38. The read image file 40 is temporarily stored in the RAM 66. And then, the main controller 62 reads the thumbnail image data 44 (see FIG. 2) from the respective image files 40 stored in the RAM 66. Successively, the main controller 62 changes the map image 90 (see FIG. 5) displayed on the LCD 78, to a list of the thumbnail images 96 (see FIG. 4) via the LCD driver 76.

After the list of the thumbnail images 96 has been shown on the LCD 78 such as shown in FIG. 4, a user handles the operating portion 68 (see FIG. 3), which corresponds to a destination selector of the present invention, to move a cursor 98. The user moves the cursor 98 to the thumbnail image 96 to be set as the destination and determines the thumbnail image 96 of the destination by handling the operating portion 68.

Upon determining the thumbnail image 96 of the destination, the shooting-position-data extracting portion 86 extracts the shooting position data 50 (see FIG. 4) from the image file 40 corresponding to the thumbnail image 96 of the destination, such as shown in FIG. 3. Thus, the latitude data and the longitude data of the destination are obtained. The shooting position data 50 regarded as the positional data of the destination is inputted into the main controller 62. After inputting the shooting position data 50 into the main controller 62, route searching is commenced by the above-described route searching portion 80.

The route searching portion 80 performs the route searching from the present location to the destination on the basis of the present location data and the shooting position data 50 inputted into the main controller 62. And then, the route searching portion 80 inputs a search result of the route searching into the main controller 62.

The main controller 62 changes the display of the LCD 78 to the above-mentioned map image 90 such as shown in FIG. 5. After that, the main controller 62 shows the icon 92 indicating the present location, an icon 100 indicating the destination, and a traveling route 102 leading from the present location to the destination on the map image 90. The user can reach the set destination by driving the automobile in accordance with the traveling route 102 shown on the map image 90.

In the car navigation equipment 60 of this embodiment, it is possible to set a plurality of destinations. In this case, when the list of the thumbnail images 96 (see FIG. 4) is displayed on the LCD 78, the thumbnail image 96 of the final destination is determined first by handling the operating portion 68. Successively, the thumbnail image 96 of the halfway destination is determined by handling the operating portion 68. Upon determining the thumbnail images 96 of the final destination and the halfway destination, the shooting-position-data extracting portion 86 extracts the shooting position data 50 from the corresponding image file 40 to input this data into the main controller 62.

On the basis of the present location data, the shooting position data 50 of the final destination, and the shooting position data 50 of the halfway destination which are inputted into the main controller 62, the route searching portion 80 searches the route leading from the present location to the final destination via the halfway destination. And then, the route searching portion 80 similarly inputs a route search result into the main controller 62.

As shown in FIG. 6, the main controller 62 shows, on the map image 90, the icon 92 indicating the present location, an icon 100a indicating the halfway destination, an icon 100b indicating the final destination, a traveling route 102a leading from the present location to the halfway destination, and a traveling route 102b leading from the halfway destination to the final destination. The user can reach the final destination via the halfway destination by driving the automobile in accordance with the traveling routes 102a and 102b displayed on the map image 90. Incidentally, although the sole halfway destination is selected in this embodiment, it is possible to select a plurality of halfway destinations.

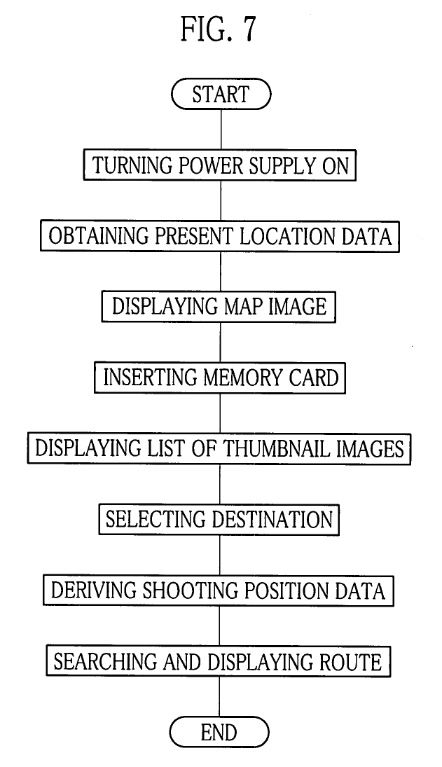

Next, a route searching process of the car navigation equipment 60 is described below with reference to a flowchart shown in FIG. 7. Power supply of the car navigation equipment 60 is turned on in association with engine start of the automobile (not shown). Upon this, the present-location-data calculator 70 calculates the present location data of the automobile by receiving the radio waves from the GPS satellites (not shown) via the GPS antenna 72. The calculated present location data is inputted into the main controller 62.

The main controller 62 searches the map-data storage portion 74 on the basis of the inputted present location data to read the road map data of the vicinity of the present location from the map-data storage portion 74. Further, the main controller 62 displays the map image 90 on the LCD 78 via the LCD driver 76. At the same time, the icon 92 indicating the present location of the automobile is displayed on the map image 90 (see FIG. 5).

Successively, the user inserts the memory card 38 into the card slot 82. The memory card 38 stores the image files 40 in advance. The image files 40 are obtained by taking the subjects regarded as the destinations (sightseeing spots, facilities, shops and so forth) with the electronic camera 10. Upon inserting the memory card 38 into the card slot 82, the media controller 84 reads the respective image files 40 from the memory card 38. The read image files 40 are temporarily stored in the RAM 66. And then, the main controller 62 reads the thumbnail image data 44 from the image file 40 stored in the RAM 66 to change the display of the LCD 78 to the list of the thumbnail images 96 via the LCD driver 76 (see FIG. 4).

After the list of the thumbnail images 96 has been displayed on the LCD 78, the user determines the thumbnail image 96 of the destination by handling the operating portion 68. Incidentally, in setting the halfway destination, the user may determine the thumbnail image 96 of the halfway destination after determining the thumbnail image 96 of the final destination. Upon determination of the thumbnail image 96 of the destination, the shooting-position-data extracting portion 86 extracts the shooting position data 50 from the image file 40 corresponding to the thumbnail image 96. The extracted data 50 is inputted into the main controller 62.

The route searching portion 80 searches a route leading from the present location to the destination, on the basis of the present location data and the shooting position data 50 inputted into the main controller 62. When the halfway destination is set, the route searching portion 80 searches a route leading from the present location to the final destination via the halfway destination. After completing the route search, the route searching portion 80 inputs a search result into the main controller 62.

The main controller 62 changes the display of the LCD 78 to the above-mentioned map image 90. After that, on the basis of the route search result, the main controller 62 shows, on the map image 90, the icon 92 indicating the present location, the icon 100 indicating the destination, and the traveling route 102 leading from the present location to the destination (see FIG. 5). When the halfway destination is set by one, for example, the main controller 62 shows, on the map image 90, the icon 100a indicating the halfway destination, the icon 100b indicating the final destination, the traveling route 102a leading from the present location to the halfway destination, and the traveling route 102b leading from the halfway destination to the final destination. By virtue of this, the user can reach the destination (the halfway destination and the final destination) by driving the automobile in accordance with the traveling route 102 (102a and 102b) displayed on the map image 90.

When it is required to change the destination before reaching there, the above-described setting of the destination is performed again after inserting the memory card 38, in which the image file 40 obtained by taking the destination to be newly set is stored, into the card slot 82.

As described above, in the car navigation equipment 60 of this embodiment, the route search is performed by utilizing the shooting position data (destination position data) added to the image file 40 obtained by taking the destination with the electronic camera 10. Thus, when there is the image file 40 obtained by taking the destination with the electronic camera 10, setting the destination is easily performed without inputting the address, the phone number and so forth of the destination as conventionally performed. Moreover, even when the address, the phone number and so forth of the destination are unknown or are forgotten, it is possible to set the destination.

Incidentally, the route search is performed with the car navigation equipment 60 of the above embodiment on the assumption that the user has the image file 40 of the destination. In this regard, searching the route with the car navigation equipment 60 is often required in a case that the destination is the first-time place. In such a case, the user seldom has the image file 40 of the destination. In view of this, a user may obtain the image file 40 of the destination via the Internet and so forth.

As shown in FIG. 8, the image file 40 obtained by taking the destination with the electronic camera 10 is sent to a personal computer (PC) 112 of a user via the Internet 110. The user receives the image file 40 by the PC 112 and copies the received image file 40 in the memory card 38 inserted into a card slot 112a of the PC 112. Successively, the user inserts the memory card 38, in which the image file 40 is copied, into the card slot 82 of the car navigation equipment 60. Thus, the image file 40 of the destination is read into the car navigation equipment 60 so that it is possible to set the destination. By the way, a cell-phone, a PDA and so forth having an Internet access function may be used instead of the PC 112.

Meanwhile, when the destination is a sightseeing spot, a facility, a shop and so forth, a home page (not shown) thereof is often established on the Internet 110. In consideration of this, the image file 40 obtained by taking the destination with the electronic camera 10 is adapted to be downloaded from the home page. Consequently, the user can download the image file 40 of the destination to the PC 112 via the Internet 110. As a result, it is possible to similarly perform the setting of the destination with the car navigation equipment 60.

In this way, setting the destination can be performed with the car navigation equipment 60 by obtaining the image file 40 of the destination via the Internet 110, even when the user does not have the image file 40 of the destination.

In the above embodiment, the GPS-equipped electronic camera 10 is described as the imaging device capable of adding the shooting position data to the image data (file) obtained by taking the destination. The present invention, however, is not limited to this. For example, various GPS-equipped imaging devices of a GPS-equipped camera cell-phone and so forth may be used instead of the electronic camera 10.

In the above embodiment, the memory card 38 storing the image file 40 of the destination is inserted into the car navigation equipment 60. The present invention, however, is not limited to this. For example, the electronic camera 10 and the car navigation equipment 60 may be provided with radio interfaces to wirelessly connect them. By doing so, the image file 40 is sent from the electronic camera 10 to the car navigation equipment 60. Further, the PC 112 and the car navigation equipment 60 may be provided with radio interfaces to wirelessly connect them (see FIG. 8). In this case, the radio interface attached to the car navigation equipment 60 corresponds to the image-file inputting portion of the present invention.

In the above embodiment, the car navigation equipment 60 is described as the route searching device for searching the route leading from the present location to the destination. The present invention, however, is not limited to this. The present invention may be adopted to various route searching devices of a cell-phone and so forth having a navigation function (route searching function), for example.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A route searching device for searching a route leading from a present location to a destination, comprising:
a data obtaining portion for obtaining present-location data representing said present location;
a map-data storage portion for storing map data;
an image-file input portion for inputting an image file in which destination-position data representing a position of said destination is added in advance to image data representing an image of the destination; and
a route searching portion for searching said route leading from said present location to said destination on the basis of said present-location data, said map data and said destination-position data of said image file.

2. The route searching device according to claim 1, further comprising:
a display for showing the images of the destinations corresponding to the respective image files when a plurality of said image files have been inputted into said image-file input portion; and
a destination selector for selecting a single image from among the images of the destinations shown on said display;
wherein said route searching portion searches the route leading from said present location to the selected destination.

3. The route searching device according to claim 2, wherein said display shows the route, which is searched by said route searching portion, instead of the image of the destination when the single image has been selected by said destination selector.

4. The route searching device according to claim 1, further comprising:
a display for showing the images of the destinations corresponding to the image files when a plurality of said image files have been inputted into said image-file input portion;
a destination selector for selecting an image of a halfway destination and an image of a final destination from among the images of the destinations shown on said display; and
an extract portion for extracting said destination-position data from said image files corresponding to the images of all the destinations selected by said destination selector;
wherein the route searching portion searches the route leading from said present location to said final destination via said halfway destination on the basis of all the destination-position data extracted by said extract portion.

5. The route searching device according to claim 4, wherein said display shows the route, which is searched by said route searching portion, instead of the image of the destination after the images have been selected by said destination selector.

6. The route searching device according to claim 1, wherein said image file is produced by an imaging device capable of adding shooting position data, which represents a position where shooting has been performed, to said image data as said destination-position data.

7. The route searching device according to claim 6, wherein said shooting position data includes latitude data and longitude data of the position where shooting has been performed.

8. The route searching device according to claim 6, wherein said image file to be inputted into said image-file input portion is produced by said imaging device and is obtained via the Internet.

9. The route searching device according to claim 1, wherein said data obtaining portion for obtaining said present-location data comprises:
a present-location-data calculator for calculating latitude and longitude of the present location as said present-location data on the basis of radio waves received by a GPS antenna.
